(19) United States
(12) Patent Application Publication
(10) Pub. No.: US 2026/0177488 A1
(43) Pub. Date: Jun. 25, 2026

(54) Multi-functional optical imaging system

(71) Applicants: James Jiang, Long Valley, NJ (US); Nada Boustany, Basking Ridge, NJ (US)

(72) Inventors: James Jiang, Long Valley, NJ (US); Nada Boustany, Basking Ridge, NJ (US)

(21) Appl. No.: 18/987,099

(22) Filed: Dec. 19, 2024

(51) Int. Cl. G01N 21/64; G01N 21/65; G02B 21/12; G02B 21/16

(52) U.S. Cl. CPC G01N 21/6458; G01N 21/65; G02B 21/12; G02B 21/16

(57) ABSTRACT

This invention discloses a multi-functional optical microscopy imaging system that integrates multiple imaging techniques, including fluorescence lifetime imaging, bright-field microscopy, Raman microscopy, and one sample manipulation technique, optical tweezers, in a single microscope setup. This allows for the acquisition of structural, functional, and molecular information from the sample with simultaneous sample manipulation function. Various design approaches have been outlined for a multi-modality microscopy by segmenting the entire operational wavelength range of an objective lens into separate spectral channels, each dedicated to a specific optical technique.

### FIELD OF THE INVENTION

The field of this invention is Multi-Functional Optical Microscopy Imaging. It involves the integration of a laser-induced sample manipulation function with various optical imaging techniques in a single optical instrument.

### BACKGROUND

A multi-functional optical imaging system combines techniques like fluorescence lifetime imaging, bright-field imaging, Raman microscopy, optical coherence tomography, and laser-sample interaction functions like optical tweezers and photoactivation into one platform. This integration facilitates a detailed analysis by merging structural, functional, and molecular data, which single techniques might not fully capture. The advantages include collecting various data types from a single specimen, enhancing biological insights by integrating data, saving lab space and costs by managing one system instead of many, and improving efficiency by reducing sample handling and degradation. The inclusion of optical tweezers allows for precise sample manipulation, improving imaging quality and enabling dynamic study of cellular responses. These systems offer real-time data collection across modalities, providing a thorough view of biological processes and adaptability for quick experimental changes. However, they come with challenges like complex design, increased costs, and difficulties in managing and interpreting large data sets. Advanced software supports data analysis, facilitating tasks like 3D reconstruction or co-localization, and minimizes experimental variability for more consistent results. Overall, these systems overcome the limitations of individual imaging modalities, serving as a versatile tool for both research and clinical use.

Fluorescence Lifetime Imaging Microscopy (FLIM) provides significant benefits in biomedical and materials science research. By measuring the fluorescence lifetimes, which are unaffected by the concentration of fluorophores, FLIM gives reliable information about the molecular environment. It is effective in detecting changes in pH, ion concentrations, and molecular interactions, ideal for analyzing cell signaling and metabolic activity. FLIM is especially useful for Förster Resonance Energy Transfer (FRET) studies, allowing for the examination of protein-protein interactions. It also improves tissue imaging by differentiating between fluorophores with overlapping emission spectra, thereby providing high contrast and sensitivity in complex biological specimens. Its non-invasive approach is crucial for live-cell imaging.

Bright-field microscopy captures images from large sample areas simultaneously, making it ideal for quick surveys or live-cell dynamics over broad fields. This setup typically uses an illumination light source to flood illuminate the sample, and uses a magnifying objective and an area-scan camera to capture a 2D image of the sample. The simplicity and cost-effectiveness of bright-field microscopy make it a staple in biological research, particularly for initial sample screening, pathology, and observing developmental processes. Despite its limitations with depth-related clarity, it provides essential, rapid insights into biological samples'wider dynamics.

Optical tweezers, commonly referred to as optical trapping or laser trapping, is a powerful tool in biophysics and materials science. It uses focused laser beams to trap and manipulate microscopic particles with high precision. This non-invasive technique allows researchers to study molecular interactions, measure forces at the nanoscale, and control the motion of biological structures like cells, DNA, and proteins. Optical tweezers enable the investigation of single-molecule mechanics, such as unfolding proteins or stretching DNA, providing insights into fundamental biological processes. Additionally, they are valuable in microfluidics for manipulating cells and particles in lab-on-chip devices. The versatility and precision of optical tweezers make them essential for advanced research in nanotechnology and biology.

Raman microscopy is a non-destructive imaging technique that combines Raman spectroscopy with optical microscopy to provide detailed chemical and molecular information at a microscopic scale. It works by analyzing the inelastic scattering of light (Raman scattering) from a sample when it is illuminated by a laser. In this process, most of the light is elastically scattered (Rayleigh scattering), but a small fraction undergoes a shift in energy due to interactions with molecular vibrations in the sample, revealing its chemical composition. Raman microscopy provides a molecular fingerprint of materials, allowing for the identification and differentiation of various chemical compounds.

Optical coherence tomography (OCT) microscopy is a non-invasive imaging technique that provides high-resolution, three-dimensional images of biological tissues by measuring the echo time delay and intensity of backscattered light. This method leverages the principles of low-coherence interferometry to achieve micrometer-scale resolution, allowing for detailed visualization of structures in vivo without the need for staining or sectioning. OCT microscopy is particularly valuable in ophthalmology, cardiology, and dermatology, offering insights into tissue morphology and pathology. Its ability to penetrate several millimeters into tissue while maintaining high resolution makes it an indispensable tool for both clinical diagnostics and research in understanding microstructural changes.

Integrating FLIM, optical tweezers, brightfield microscopy, Raman microscopy, and OCT into one microscope platform revolutionizes biological and material science research. FLIM measures how long fluorescence lasts, revealing molecular interactions, environmental shifts, protein folding, and DNA dynamics, ideal for live-cell imaging without markers. Optical tweezers complement this by allowing manipulation and study of mechanical forces on cells or particles, providing insights into how these forces affect biological processes. Brightfield microscopy gives a basic yet clear view of cell structures, helping to correlate molecular and chemical data with physical changes. Raman microscopy, through vibrational spectroscopy, offers chemical analysis without labels, enhancing FLIM's molecular insights and reducing sample disturbance. OCT adds depth with its high-resolution, 3D imaging of tissues, showing how molecular events affect tissue structure across different medical fields.

Together, these techniques provide a comprehensive toolset for detailed manipulation, imaging, and analysis of biological samples. This setup not only optimizes experimental workflows and minimizes sample manipulation but also offers a profound understanding of complex biological systems, from the molecular scale to tissue level, all within a single, versatile platform.

### PRIOR ARTS

A paper, “Time-gated autofluorescence microscopy of motile green microalga in an optical trap,” published in Cellular and Molecular Biology, 1998, 44, 763-70, describes a method using a 1047 nm laser for optically trapping microbeads and motile cells, and measuring sample lifetime with the time-domain method. The primary disadvantage of this approach is the expensive use of an ultrafast gated intensified CCD (ICCD) camera for measuring fluorescence signal intensity at varied time delays post-excitation.

Additionally, since the ICCD captures the entire field of view at once, it collects light from various sample depths, resulting in blurred images when imaging thicker specimens. The system's poor depth sectioning capability further reduces image sharpness due to out-of-focus light contributing to the signals. This limitation in depth discrimination makes it less ideal for 3D fluorescence lifetime imaging in thick or multilayered samples. A further limitation is the absence of any means to measure the force of the optical tweezers applied to the particles.

A paper, “Optical tweezers in single-molecule biophysics,” published in Nature Reviews Methods Primers, 2021, 1, Article 25, discusses a method to manipulate and measure forces on single molecules, alongside detecting fluorescence emissions using a confocal microscope setup. However, this setup has several drawbacks: it measures force through transmission light collected by the condenser lens, not the objective lens, making it unsuitable for thick samples; employs two out-of-phase acousto-optic modulators for modulating the trap and fluorescence excitation lasers in an interleaving mode, thus only achieving a 50% imaging duty cycle; uses visible blue light for bright-field illumination which might excite unwanted fluorescence from certain samples, not optimal for broad-range fluorescence imaging. As illustrated in FIG. 4f of this paper, the measured fluorescence lifetime is in the milliseconds range not in the nanosecond range, limiting its applications for Förster Resonance Energy Transfer (FRET).

A paper, “Optically trapped microsensors for microfluidic temperature measurement by fluorescence lifetime imaging microscopy,” published in Lab on a Chip, 2011, 11, 3821-3828, describes a method for conducting both optical tweezer operations and FLIM imaging simultaneously, though it does not measure the optical tweezer force. The FLIM measurements utilize a time domain approach with an ICCD to capture full-field images, which lacks the capability for depth sectioning of the sample. A significant drawback is the use of white illumination light to monitor the optical tweezer beam, which interferes with FLIM operations because the ICCD camera is very sensitive to visible wavelengths, making it impossible to simultaneously observe the tweezer operation and measure FLIM images.

A paper, “Enhancing Double-Beam Laser Tweezers Raman Spectroscopy (LTRS) for the Photochemical Study of Individual Airborne Microdroplets,” published in Molecules, 2019, 24, 3325-3327, outlines a method that integrates confocal Raman microscopy with optical tweezers, utilizing two objective lenses—one for the Raman laser beam and another for the optical tweezer—to allow for independent numerical aperture (N.A.) control. This setup is beneficial because the tweezer requires a tight focus to trap particles as small as a few microns or nanometers, while a moderate NA suffices for Raman scattering. However, this system is more costly and larger than those using a single objective lens, and the alignment of two objectives requires meticulous calibration, making maintenance of the system more difficult. Additionally, the system does not include the capability to measure the sample's fluorescence lifetime.

A review paper “Raman Imaging and Fluorescence Lifetime Imaging Microscopy for Diagnosis of Cancer State and Metabolic Monitoring,” published in Cancers, 2021, 13, 5682-5714, highlights the integration of these two imaging modalities for the purposes of early cancer detection, metabolic analysis, and monitoring of cancer therapies. FIG. 1 in this paper provides a schematic for a combined Raman and FLIM system using the same objective, yet lacks specifics on the selection of FLIM and Raman laser wavelengths as well as detection ranges. The figure is conceptual rather than depicting a newly constructed instrument by the authors; the paper instead focuses on reviewing the current state of technology and advancements in Raman and FLIM for cancer diagnostics. FIG. 2 showcases Raman and FLIM images from various cancer tissues to demonstrate the diagnostic potential of these techniques, although these images are not from the same samples nor captured concurrently. The system described does not incorporate an optical tweezer nor bright-field microscopy capabilities.

A product application note “Fluorescence lifetime imaging microscopy” by Renishaw (October 2023) outlines the integration of FLIM into the Renishaw inVia confocal Raman microscope, creating a system that combines Raman spectroscopy and FLIM. It employs an optical design where both the Raman and FLIM laser beams utilize the same optical path, with automated switching between modes managed by the instrument's software using selectable mirrors and components. However, this means the system cannot produce Raman and FLIM images at the same time. The setup uses a 405 nm laser for FLIM excitation and a 532 nm laser for Raman excitation. The detection of Raman scattering is within the 550 nm to 800 nm range, where strong fluorescence from FLIM excitation could overlap, causing potential signal contamination when working simultaneously. The system also does not incorporate optical tweezers or bright-field microscopy functionalities.

A paper, “Multimodal Scanning Microscope Combining Optical Coherence Tomography, Raman Spectroscopy and Fluorescence Lifetime Microscopy for Mesoscale Label-Free Imaging of Tissue,” published in Analytical Chemistry, 2021, 93, 11479-11487, details a system integrating OCT, Raman spectroscopy, and FLIM. This setup employs a long focal length achromatic doublet lens (Edmund Optics #45-210, f=35 mm) as the objective with an XY galvo scanner in an f-theta configuration, positioning the beam scanning axis near the back focal plane of the lens. However, the small beam diameter relative to the full aperture of the lens results in a very low N.A. of about 0.1, limiting the lateral resolution to around 12.5 micrometers, which is inadequate for sub-micron imaging of cellular structures, thus constraining its application in biological research. In the bright-field imaging setup, a CCD camera is positioned behind a semi-transparent scanning mirror, leading to motion artifacts and optical path length modulation that degrade image quality for high-resolution imaging. This system lacks optical tweezers functionality and operates across a broad wavelength range from 355 nm to 1400 nm. Designing an objective lens with an N.A. larger than 0.7 for this range is both technically and economically challenging. Consequently, to achieve sub-micron high-resolution imaging and incorporate optical tweezers for sample manipulation, a novel optical system design is required.

### SUMMARY

This application discloses the design of a multi-functional microscope imaging system capable of simultaneously performing several imaging techniques along with sample manipulation using laser tweezers on a single instrument. Specifically, the system integrates the following functions: 1) Fluorescence Lifetime Imaging Microscopy, 2) Bright-field Microscopy, 3) Optical Tweezers, and 4) Raman Microscopy. All of these functions are achieved through a single objective lens, simplifying the system's configuration and maintenance. The integration of these techniques into one instrument is accomplished using free-space optics, avoiding the need for optical fibers for beam delivery and collection. This design choice enhances the optical throughput and contributes to a more compact system. The system preferably employs diode lasers, known for their compact size and low cost, though more sophisticated laser sources, such as ultrafast lasers, could also be used.

Special attention has been given to minimizing signal crosstalk between the different imaging modalities. The broadband operational range of a high-quality microscope objective, typically spanning from 350 nm to 1100 nm, is leveraged to assign specific wavelength ranges to each function. For instance, the FLIM function operates within the shortest wavelength range (e.g., 400 nm to 600 nm), while Raman microscopy utilizes the longest wavelength range (e.g., 660 nm to 1000 nm). By separating the FLIM and Raman ranges, potential fluorescence contamination of the Raman signals is minimized. The bright-field microscopy and optical tweezers functions operate in the intermediate wavelength range, situated between FLIM and Raman wavelength channels. For example, bright-field microscopy uses wavelengths from 600 nm to 630 nm, while optical tweezers operate within the 630 nm to 650 nm range. This careful wavelength separation ensures minimal interference between the various imaging modalities.

### DESCRIPTIONS OF FIGURES

FIG. 1 shows a high-level diagram of the multi-functional optical imaging system, which includes four functional subsystems with partially overlapping optical paths through the same objective lens.

FIG. 2 illustrates a detailed design of the multi-functional optical imaging system, optimized for a wide wavelength detection range in its fluorescence lifetime imaging subsystem.

FIG. 3 highlights the fluorescence lifetime imaging subsystem isolated from the system shown in FIG. 2.

FIG. 4a highlights the bright-field microscopy imaging subsystem isolated from the system in FIG. 2.

FIG. 4b illustrates a design of a reflective LED ring illuminator for a high NA objective lens for the bright-field microscopy imaging subsystem.

FIG. 5 highlights the optical tweezers subsystem isolated from the system in FIG. 2.

FIG. 6 highlights the Raman microscopy imaging subsystem isolated from the system in FIG. 2.

FIG. 7 illustrates another detailed design of the multi-functional optical imaging system, optimized for the maximum Raman shift detection range in its Raman microscopy imaging subsystem.

FIG. 8 highlights the fluorescence lifetime imaging subsystem isolated from the system shown in FIG. 7.

FIG. 9 highlights the bright-field microscopy imaging subsystem isolated from the system in FIG. 7.

FIG. 10 highlights the Raman microscopy imaging subsystem isolated from the system in FIG. 7.

FIG. 11 highlights the optical tweezers subsystem isolated from the system in FIG. 7.

FIG. 12 illustrates another detailed design of the multi-functional optical imaging system which is similar to the system in FIG. 2, only replacing the Raman microscopy imaging subsystem with an optical coherence tomography imaging subsystem.

### DETAILED DESCRIPTIONS OF FIGURES

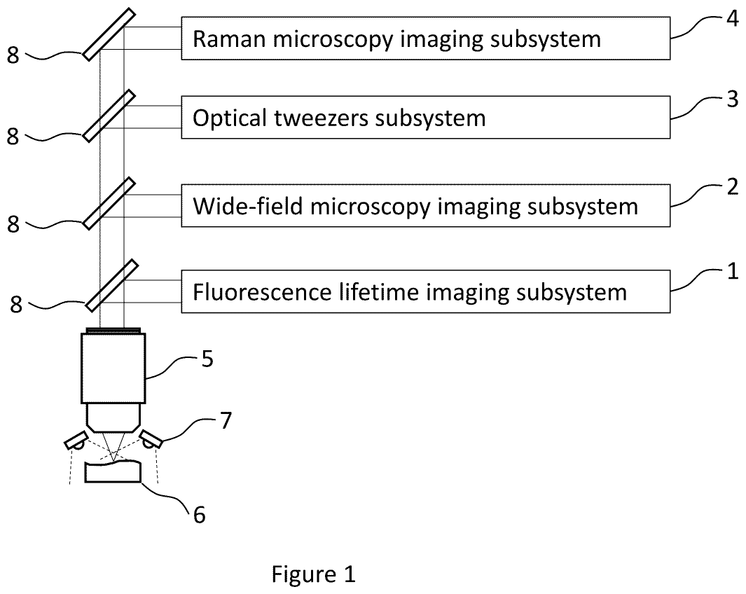

FIG. 1 illustrates one embodiment of the multi-functional optical imaging system. The system is built on a microscope platform and consists of four subsystems that share a single objective lens. The objective lens is designed to operate across a broad wavelength range from an ultraviolet wavelength of ˜350 nm to a near-infrared wavelength of ˜1100 nm. These four subsystems include a fluorescence lifetime imaging subsystem (1), a bright-field microscopy imaging subsystem (2), an optical tweezers subsystem (3), and a Raman microscopy imaging subsystem (4). The subsystems share partially overlapping optical paths and can function independently or simultaneously.

In this system, multiple dichroic beam splitters (8) are used to separate the optical beam passing through the objective lens (5) into four distinct wavelength channels, with each subsystem operating within one wavelength channel. The fluorescence lifetime imaging subsystem (1) operates within the first wavelength channel at the shorter end of the objective's wavelength range, generating fluorescence lifetime images of the sample (6). This is because most fluorophores are designed to absorb UV and short-wavelength light for excitation, while emitting fluorescence at longer wavelengths. This first wavelength channel covers both the excitation and emission wavelengths of the fluorophores to be imaged.

The bright-field microscopy imaging subsystem (2) operates in the second wavelength channel, which is longer than the first channel. This subsystem requires an illuminator (7) which is a light source emitting light only in this wavelength channel for sample illumination, in either reflection or transmission configuration.

The optical tweezers subsystem (3) functions in the third wavelength channel, which is longer than the first channel but different from the second channels. This subsystem uses a collimated laser beam which functions as optical tweezers for sample manipulation and force measurement functions.

The Raman microscopy imaging subsystem (4) operates in the fourth wavelength channel, which is the longest among all the wavelength channels, typically in the red and near-infrared range (e.g., 640 nm to 1100 nm), encompassing both the Raman excitation and emission wavelengths. This choice of wavelength is strategic because effective Raman signals often require significant excitation power. If the Raman subsystem were to operate at shorter wavelengths, the excitation light could induce fluorescence signals, contaminating the data in other channels, especially the fluorescence lifetime imaging subsystem. Additionally, selecting the longest wavelength range available for the objective lens for Raman measurements is advantageous because most silicon-based detectors exhibit higher photovoltaic responsivities (A/W) between 650 nm and 1050 nm.

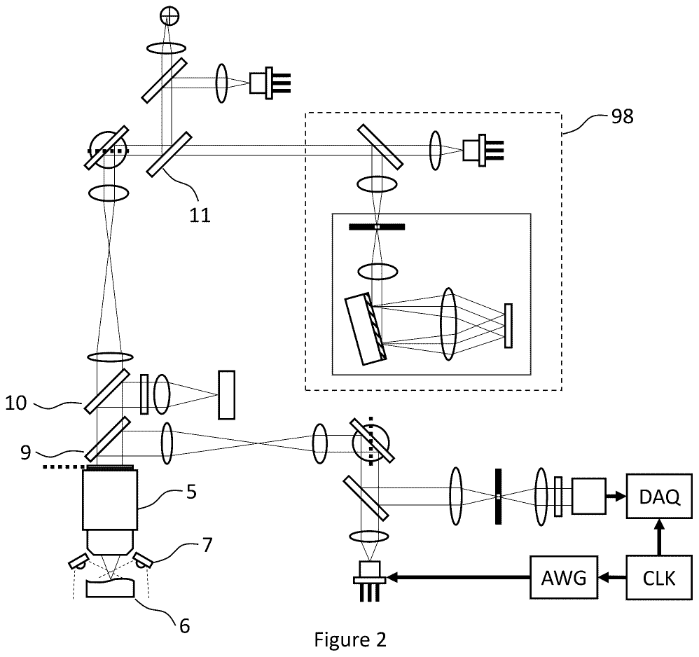

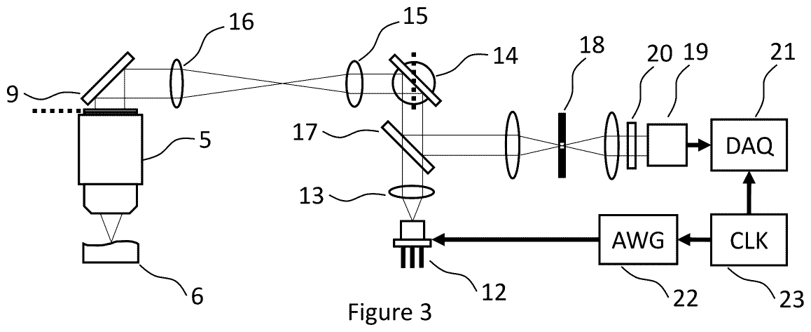

FIG. 2 shows a detailed design of the multi-functional optical imaging system. This system integrates all four subsystems which share the same microscope objective lens (5) and have partially overlapping optical paths. An example objective is the water immersion Nikon NIR Apo 60× with a numerical aperture of 1.0 and working distance of 2.8 mm. This objective supports wavelength from 380 nm to 1100 nm and is challenging to design and has a high production cost. Dichroic beam splitters are employed to separate the wavelength channels for each subsystem. The first dichroic beam splitter (9), located behind the objective lens, directs wavelengths from 350 nm to 700 nm into the first wavelength channel for the fluorescence lifetime imaging subsystem. This beam splitter, such as the Thorlabs DMLP700, reflects all wavelengths shorter than 700 nm and passes wavelengths longer than 700 nm. The second dichroic beam splitter (10), positioned behind the first one, reflects wavelengths from 710 nm to 720 nm into the second wavelength channel for the bright-field microscopy imaging subsystem and transmits all wavelengths longer than 720 nm. The third dichroic beam splitter (11) selects the third wavelength channel, from 720 nm to 750 nm, for the optical tweezers subsystem, while passing all wavelengths longer than 750 nm into the fourth wavelength channel for the Raman microscopy imaging subsystem. The Thorlabs DMLP750 filter can be used for this purpose which reflects wavelengths shorter than 750 nm and transmits wavelengths longer than 750 nm. The detailed operation of these four subsystems is further explained in FIGS. 3 through 6, which are selected from FIG. 2 to be highlighted.

FIG. 3 illustrates the fluorescence lifetime imaging subsystem within the multi-functional optical imaging system shown in FIG. 2. In this subsystem, the output beam from an amplitude-modulated, 405 nm diode laser (12) is collimated by a lens (13) and then scanned by an XY beam scanner (14) before entering the back aperture of the objective lens 5. A pair of relay lenses (15) and (16) positioned between the scanner and the objective lens forms a 4f optical system, which optically projects the beam's pivoting axis to the back aperture entrance of the objective (5). In this 4f optical configuration, the distance from the scanner axis (14) to the first lens (15) matches the focal length of the first relay lens (15), and the distance from the entrance aperture of the objective (5) to the second relay lens (16) matches the focal length of the second relay lens (16). The distance between the two relay lenses (15) and (16) is the sum of the focal lengths of these two lenses, thus creating the 4f configuration. A dichroic beam splitter (9), which reflects wavelengths from 350 nm to 700 nm and transmits wavelengths longer than 700 nm, reflects the laser beam into the objective lens (5), where it is focused onto the sample (6). Fluorescence emission signals from the sample (5) are collected by the same objective lens (6), reflected by the dichroic beam splitter (9), and directed toward the scanner (14). These fluorescence emission signals are then separated from the excitation laser by another dichroic beam splitter (17) such as the Thorlabs DMLP425 filter, which transmits the excitation wavelength of 405 nm and reflects fluorescence emission signals with wavelengths longer than 425 nm. The fluorescence emission is then spatially filtered through a pinhole (18) before being recorded by a detector (19) which is a photomultiplier tube. A bandpass filter (20) is inserted between the pinhole (18) and the detector (19) to further reject photons that are out of the desired wavelength band. The output signals from the detector (19) are digitized by a data acquisition device (21) and processed to generate both fluorescence intensity and lifetime images of the sample. A single clock source (23) synchronizes the arbitrary waveform generator (22), which produces the modulation waveform for the laser, and the data acquisition device (21), which digitizes the detector output signals into digital data records. The digital data records are processed by computer software to construct fluorescence intensity and lifetime images of the sample.

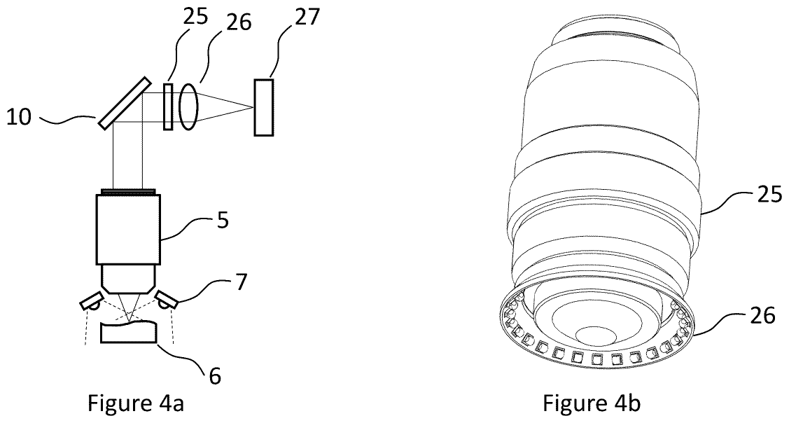

FIG. 4a shows the bright-field microscopy imaging subsystem in the multi-functional optical imaging system presented in FIG. 2. In this configuration, a reflection-mode illumination scheme is used, particularly suited for observing thick samples. The illuminated sample light between 700 nm and 720 nm is collected by the objective lens (5), reflected by a dichroic beam splitter (10), optically filtered by a bandpass filter (25) rejecting light not in this wavelength channel, and focused by a tube lens (26) onto a 2D area-scan camera (27) to generate the bright-field microscopy images of the sample. The dichroic beam splitter (10) reflects wavelengths shorter than 720 nm and transmits longer wavelengths.

FIG. 4b shows the design of the reflection-type LED ring illuminator used in the bright-field microscopy imaging subsystem, for a high numerical aperture (N.A.>0.7) objective with a sample working distance longer than 0.25 mm. A group of diffused LEDs (26) emitting light near the 710 nm wavelength are arranged in a ring configuration, positioned facing the gap between the objective lens and the sample. This illuminator can produce even and broad illumination across the entire field of view, which is crucial for high NA objectives that have a wide acceptance angle for incoming light, to achieve consistent image quality across the specimen at low cost and low power consumption. Additionally, by adjusting the LED ring to emit light at angles exceeding the NA of the objective, such as swapping ring cap designs of different illumination angles, the system can switch to dark-field illumination, which significantly enhances the contrast of transparent cells by capturing only the light scattered by the sample against a dark background.

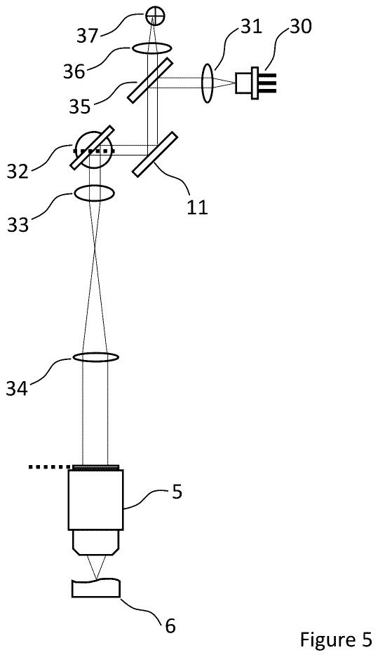

FIG. 5 shows the optical tweezers subsystem in the multi-functional optical imaging system presented in FIG. 2. In this subsystem, the light from a 730 nm diode laser (30) is collimated by a lens (31), and the collimated beam is reflected by a dichroic beam splitter (11) (Thorlabs DMLP750) which reflects wavelengths shorter than 750 nm and transmits longer wavelengths. The beam is then scanned by an XY beam scanner (32) and directed into the back aperture of the objective lens (5). A pair of relay lenses (33) and (34) is positioned between the XY beam scanner and the objective lens to form a 4f optical system, to optically project the beam's pivotal axis to the back entrance aperture of the objective. This beam serves as the optical tweezer beam, creating the optical trap at the focal point of the beam to manipulate particles in the sample (6). The backscattered light from the manipulated particles in the sample, at the same wavelength, is collected by the objective (5) and back-propagates along the incoming beam path. The scattered light is then separated from the incoming beam by a 90/10 (R/T) beam splitter (35) placed between the laser and the beam scanner, and focused onto a quadrant photodetector (QPD) (37) by a lens (36). The QPD measures the beam position change during the sample manipulation process, and uses the measured beam center shift to estimate the force applied by the optical tweezers on the particles in the sample.

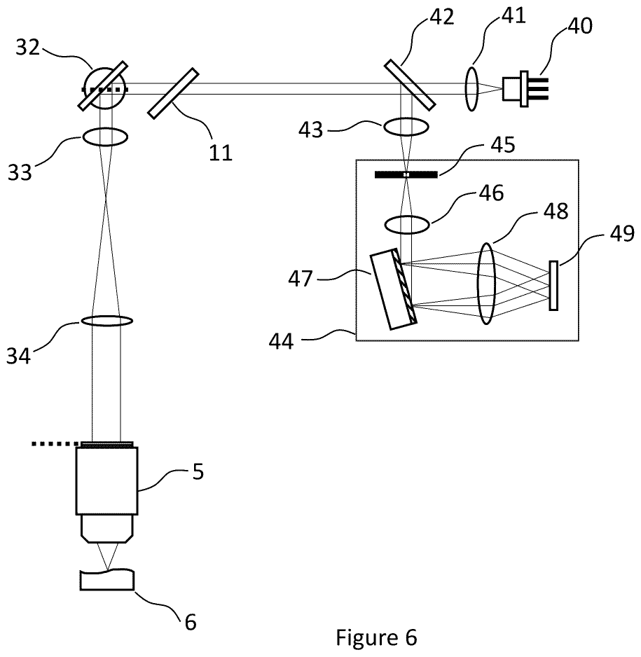

FIG. 6 illustrates the Raman microscopy imaging subsystem within the multi-functional optical imaging system depicted in FIG. 2. In this setup, a 785 nm diode laser (40) serves as the Raman excitation light source. The laser diode's light is collimated by a lens (41) and passes through the dichroic beam splitter (11), merging with the beam of the optical tweezers to share the same optical path towards the objective lens (5). The back-scattered Raman signals from the sample (6) are captured by the same objective lens (5) and travel back along the same optical path. These signals are then separated from the excitation beam by another dichroic beam splitter (42), which acts as a Raman edge filter, transmitting the 785 nm excitation light while reflecting wavelengths longer than 800 nm, since Raman photons have wavelengths longer than the excitation photons. The scattered Raman photons are focused by a collection lens (43) onto the entrance slit (45) of an optical spectrometer (44). The light entering through the slit is collimated by lens (46), then diffracted by a reflection-type grating (47). Photons of different wavelengths are diffracted in various directions and focused by a lens (48) onto different pixels of a line-scan camera (49). The outputs from the line scan camera (49) represent the Raman spectra at various sample points. By scanning the beam in two dimensions across the sample using the XY beam scanner (32), 2D Raman spectroscopy images of the sample can be generated.

In the above microscope system design, all beams pass through the same objective, with different functional subsystems using distinct wavelength channels. The fluorescence lifetime imaging subsystem uses the shortest wavelengths, from 400 nm to 700 nm, matching the absorption and emission of most fluorophores. The bright-field microscopy imaging operates in the channel just above the FLIM range. The optical tweezers are implemented in the third wavelength channel, longer than the bright-field channel, and Raman microscopy functions in the fourth channel, from 750 nm to 1100 nm. Using a 785 nm laser for Raman excitation and detecting signals from 800 nm to 1100 nm, the upper limit of 1100 nm is set by the sensitivity of standard Si-based line-scan cameras and the maximum wavelength of typical microscope objectives. This configuration supports a Raman shift detection range from 239 cm⁻¹ to 2832 cm⁻¹, based on the detector's sensitivity to 1100 nm. This design optimizes the detection range for fluorescence signals but slightly restricts the Raman shift detection range. The use of optical scanners in various subsystems optically relay the beam pivoting axis to the back aperture of the objective, matching the beam size to the aperture size upon entry. This design is particularly effective for high numerical aperture (N.A.>0.7) objectives, maximizing the use of the objective's N.A. for enhanced lateral resolution and a flat focal plane. Note that this design is also applicable and performs effectively with objectives of low and medium numerical apertures.

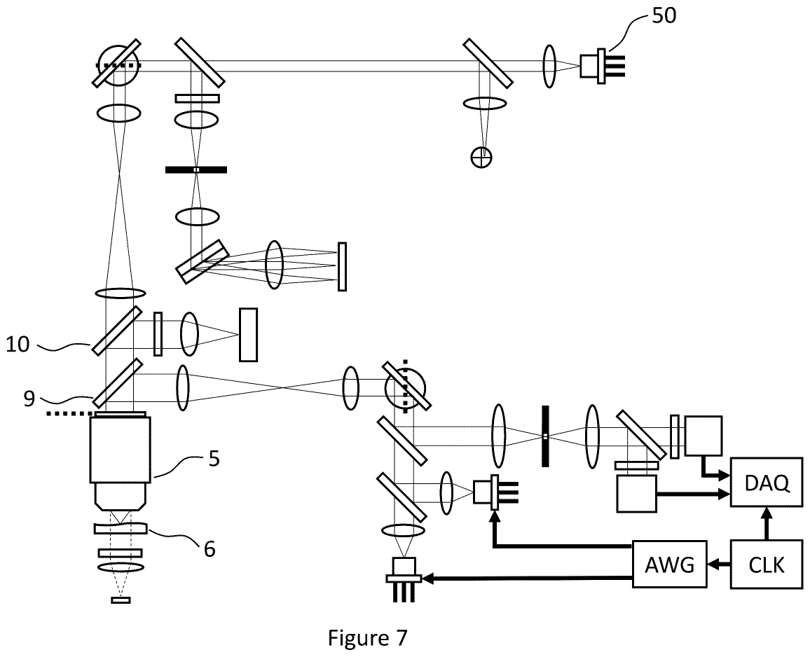

FIG. 7 shows a second embodiment of the multi-functional optical imaging system, the system is optimized for the maximum Raman shift detection range. This setup includes four subsystems: a fluorescence lifetime imaging subsystem operating in the first wavelength channel from 400 nm to 600 nm, a bright-field microscopy imaging subsystem in the second wavelength channel from 600 nm to 625 nm, a Raman microscopy imaging subsystem in the third wavelength channel from 625 nm to 1100 nm, and an optical tweezers subsystem that shares the same third wavelength channel and uses the same Raman excitation laser for optical tweezers. The dichroic beam splitter (9), which reflects wavelengths shorter than 600 nm, separates the first and second wavelength channels. The dichroic beam splitter (10), reflective to wavelengths shorter than 625 nm, distinguishes between the second and the third wavelength channels.

In contrast to the design in FIG. 2, which focuses on FLIM signal detection, the design in FIG. 7 is tailored for Raman signal detection by restricting the fluorescence signal detection range to below 600 nm and altering the Raman excitation laser from 785 nm to a lower wavelength range between 600 nm and 700 nm. In this configuration, Raman excitation comes from a high-power single-mode laser (50) operating at 642 nm (USHIO HL6385DG, 150 mW), which enhances signal strength and spectral resolution. The Raman signal detection range in this system extends from 650 nm to 1000 nm, aligning well with the peak wavelength sensitivity of the line-scan camera and the intended wavelength spectrum of the objective lens. This setup facilitates a wide Raman shift detection range, from 191 cm⁻¹ to 4489 cm⁻¹.

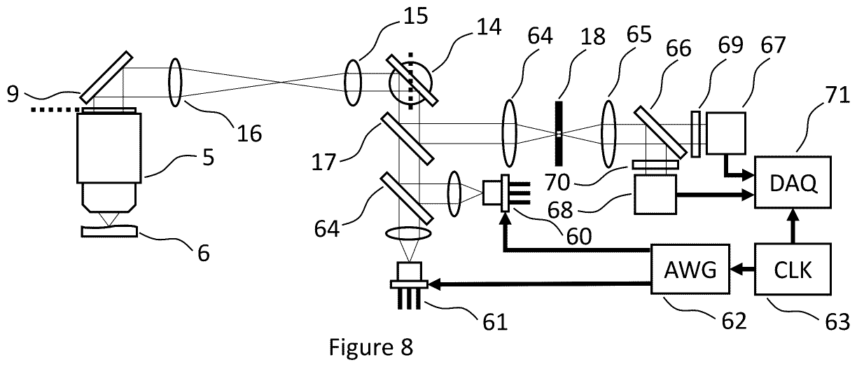

FIG. 8 shows the fluorescence lifetime imaging subsystem of the multi-functional optical imaging system in FIG. 7. This subsystem operates over a wavelength range from 400 nm to 600 nm reflective to a dichroic beam splitter (9) positioned behind the objective lens (5). Two lasers for fluorescence excitation, one laser (60) at 450 nm and another laser (61) at 520 nm, are modulated at different frequencies between 10 MHz and 100 MHz. These modulations are generated by an arbitrary waveform generator (62) with two output channels, synchronized by a clock source (63). The beams from these lasers are combined by a dichroic beam splitter (64) into one beam, which is then scanned by a galvanometer scanner (14). Relay lenses (15) and (16) project the beam's pivot axis onto the back aperture of the objective lens (5), with the sample (6) positioned at the front focal point. Fluorescence emission signals from the sample are gathered by the same objective lens (5) and travel back through the relay lenses. After the scanner (14), another dichroic beam splitter (17) separates these signals from the excitation beam. Spatial filtering occurs through a confocal pinhole setup with a focusing lens (64), a pinhole (18), and a collimation lens (68), filtering out out-of-focus signals. A further dichroic beam splitter (66) splits the signals into two channels, detected by separate detectors (68) and (69). Bandpass filters (69) and (70) are placed before these detectors to eliminate unwanted wavelengths. The analog outputs from these detectors are converted to digital by a data acquisition device (DAQ) (71). The data conversions in the DAQ (71) and waveform generator (62) are synchronized by the clock source (63).

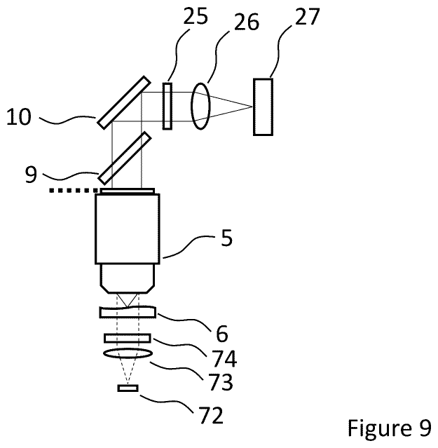

FIG. 9 depicts the bright-field microscopy imaging subsystem of the multi-functional optical imaging system in FIG. 7. This subsystem operates over a wavelength range of 600 nm to 625 nm reflective to dichroic beam splitter (10). This subsystem employs a transmission-type illuminator with a diffused LED (72), a lens (73), and a bandpass filter (74) to produce a collimated beam for illuminating sample (6) in transmission mode. After objective lens (5), the dichroic beam splitter (10) guides the light from the illuminated sample towards camera (27). An optical filter (25) is positioned before the tube lens (26) to block out-of-band wavelengths. The 2D camera (27) is situated at the focal plane of the tube lens (26) to capture bright-field microscopy images of the sample.

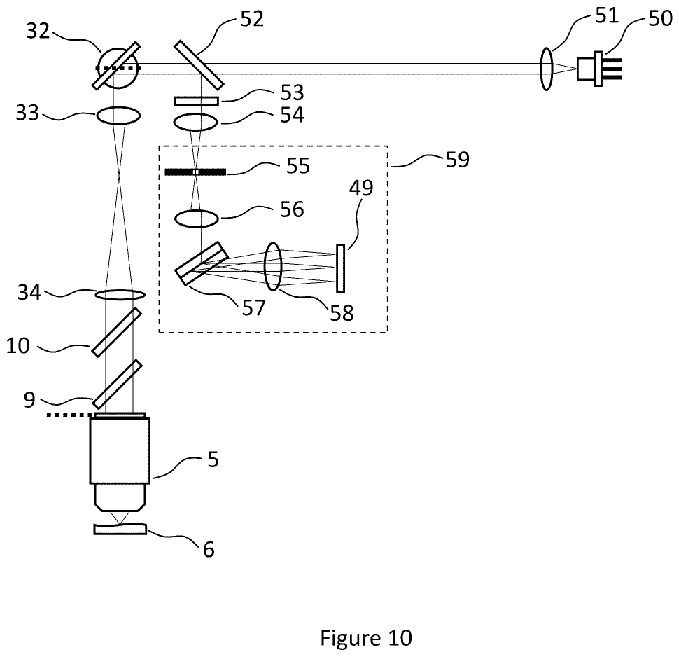

FIG. 10 illustrates the Raman microscopy imaging subsystem of the multi-functional optical imaging system as seen in FIG. 7. This subsystem operates over a wavelength range of 625 nm to 1100 nm transmission to dichroic beam splitter (10) and dichroic beam splitter (9). A high power 642 nm single-mode laser diode 50 is utilized as the Raman excitation source. The laser output is collimated by lens (51), scanned by an XY beam scanner (32), and then directed into the back aperture of the objective lens. A relay lens pair, comprising lenses (33) and (34), is placed between the XY beam scanner (32) and the objective lens (5) to create a 4f optical system, ensuring the beam's pivot axis aligns with the back aperture of objective lens (5). The back-scattered Raman signals from sample (6) are captured by the same objective (5) and travel back along the excitation path. These signals are separated from the excitation beam by a dichroic beam splitter (52) (Thorlabs DMLP650), which transmits the 642 nm excitation light while reflecting wavelengths above 650 nm. A long-pass filter (Thorlabs FELH0650) further removes any light below 650 nm, ensuring only Raman signals are detected. These signals are focused by lens (54) onto the entrance slit (55) of an optical spectrometer (59). After being re-collimated by lens (56) after the slit, the light is dispersed by a transmission grating (57), where different wavelengths are spread out and focused by lens (58) onto various pixels of a line scan camera (49). The use of a transmission grating offers benefits like higher throughput, reduced polarization dependence, and a wide operational wavelength range, enhancing the Raman shift detection capability. The output from the line scan camera (49) provides Raman spectra for different sample locations. By scanning the beam in two dimensions with the XY beam scanner (32), this subsystem can generate Raman microscopy images of the sample.

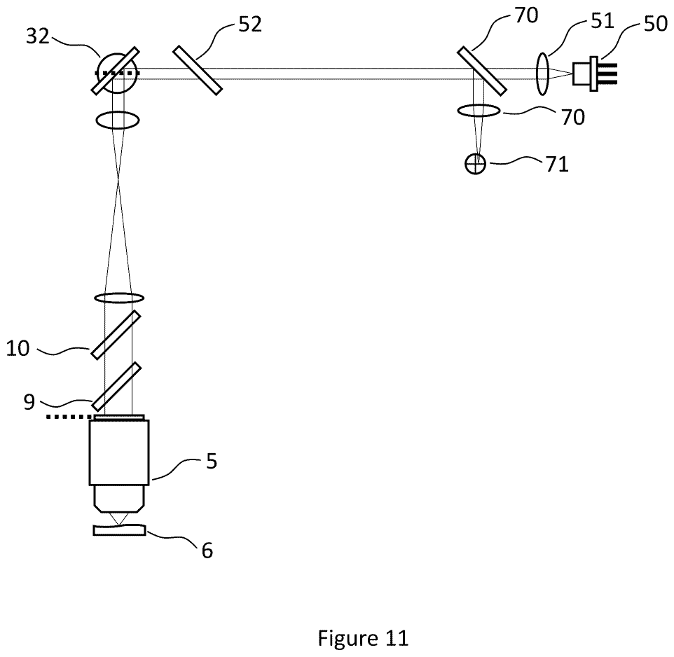

FIG. 11 depicts the optical tweezers subsystem within the multi-functional optical imaging system from FIG. 7, where the optical tweezers laser is the same laser used for Raman excitation. This approach cuts down on total system costs by not requiring an extra laser, provided that the optical tweezers and Raman imaging functions are not operating at the same time. Particle manipulation is achieved by adjusting the beam's angle with the XY beam scanner (32), which shifts the focal spot transversely at the focal plane of the objective lens (5). The effects of optical tweezers can be observed on bright-field microscopy images. To gauge the force of the optical tweezers on the particles, a 90/10 (T/R) beam splitter (70) is incorporated into the beam path. This splitter allows 90% of the excitation light to pass through while redirecting 10% of the light reflected from the sample, focusing it through lens (70) onto a quadrant photodiode (71). This setup enables the estimation of the force applied by the optical trap on the particles by analyzing the shift in beam position detected by the quadrant photodiode (71).

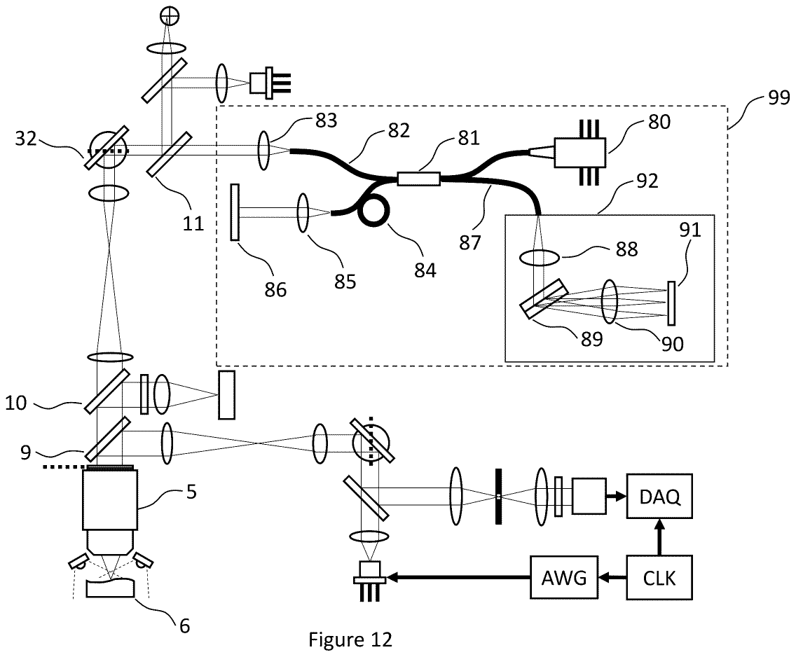

FIG. 12 illustrates a third embodiment of the multi-functional optical imaging system, which comprises four subsystems: a fluorescence lifetime imaging subsystem, a bright-field microscopy subsystem, an optical tweezers subsystem, and an optical coherence tomography (OCT) imaging subsystem. The system configuration closely resembles that depicted in FIG. 2, with the substitution of the Raman microscopy imaging subsystem (98) with the OCT imaging subsystem (99). This substitution is facilitated by the OCT's effective operation within the long wavelength range of 800 nm to 1000 nm, originally utilized for Raman microscopy. The OCT subsystem enhances the system with distinctive contrast mechanisms and depth-sectioned imaging capabilities.

In the OCT subsystem (99) of the multi-functional optical imaging system depicted in FIG. 12, a super-luminescent light emitting diode (SLED) serves as the OCT light source (80). This source emits a broad spectrum of light ranging from 820 nm to 890 nm, which is then coupled into a 2×2 single mode fiber-optic coupler (81). In the sample arm of the OCT interferometer, the light exiting from fiber (82) of the coupler (81) is collimated by a lens (83) and introduced into the imaging system. It passes through dichroic beam splitters (11), (10), and (9) before entering the microscope objective (5) to be focused onto the sample (6). The backscattered light from the sample (6) is collected by the same objective (5) and travels back along the incoming optical path to be recoupled into the single mode fiber (82).

In the reference arm of the OCT interferometer, the light from the other output fiber (84) of the 2×2 coupler (81) is collimated by a lens (85), reflected by a mirror (86) back into fiber (84), establishing an optical path with a fixed delay. This reflected light interferes with the light reflected by the sample (6) within the fiber coupler (81), generating optical interference signals which exit via a fiber (87).

These interference signals in the fiber (87) are directed to a spectrometer (92). Here, the light is collimated by a lens (88) and incident on a transmission grating (89), which disperses different wavelengths in different directions. A lens (90) then focuses these wavelengths onto various pixels of a line scan camera sensor (91), recording the OCT interference fringe signals.

When the photons from the sample arm interact with photons from a fixed optical delay in the reference arm, photons backscattered from various sample depths produce interference fringe signals at different frequencies. After calibrating the interference fringe signals in the optical frequency space, applying a Fourier transform to these signals allows differentiation of depth reflections, yielding a one-dimensional depth profile of the sample. By scanning the beam with the XY beam scanner (32) already in the optical path, two-dimensional and three-dimensional image data of the sample's internal structures and functions can be acquired.

What is claimed is:

1. A multi-functional optical imaging system comprising:
An infinity-corrected objective lens operable over a broad wavelength range, configured to examine a sample positioned near the objective's focal plane;
Multiple dichroic beam splitters arranged to separate an optical beam passing through the objective into distinct wavelength channels and beam paths for various subsystems;
A fluorescence lifetime imaging subsystem operating in a first wavelength channel at the shorter wavelength end of the range supported by the objective, configured to generate fluorescence lifetime images using a scanned optical beam, the subsystem further including a relay lens pair that aligns the beam scanning axis with the back entrance aperture of the objective, where the beam size is matched to the aperture size upon entry;
A bright-field microscopy imaging subsystem operating in a second wavelength channel, which is longer than the first, adapted to capture bright-field microscope images of the sample using a camera, with illumination provided by light within this wavelength channel;
An optical tweezers subsystem operating in a third wavelength channel, which is longer than the first but distinct from the second, configured for optical tweezers functionality to manipulate particles within the sample, including an optical beam scanner for moving the beam focused by the objective lens and a relay lens pair that aligns the beam scanning axis with the back entrance aperture of the objective, ensuring the beam size matches the aperture size upon entry; and
A Raman microscopy imaging subsystem operating in a fourth wavelength channel, which is the longest among the four, configured to measure Raman spectra at various sample locations to form Raman spectroscopy images, including an optical beam scanner for beam positioning and a relay lens pair that aligns the beam scanning axis with the back entrance aperture of the objective, where the beam size is matched to the aperture size upon entry.

2. The multi-functional imaging system of claim 1, wherein the infinity-corrected objective is designed to operate in the wavelength range from 350 nm to 1100 nm.

3. The multi-functional imaging system of claim 1, wherein the fluorescence lifetime imaging subsystem includes a fluorescence excitation laser that outputs a collimated beam scanned by a first XY beam scanner, and a relay lens pair that optically relays the beam scanning axis to the back entrance aperture of the objective, matching the beam size to the aperture size upon entry. Fluorescence emission signals from the sample back-propagate along the same optical path as the excitation beam until they pass through the first XY beam scanner, after which they are separated for detection to measure the fluorescence lifetime values at scanned sample locations, forming both fluorescence intensity and lifetime images of the sample.

4. The fluorescence lifetime imaging subsystem of claim 3, wherein the fluorescence excitation laser is intensity modulated by an analog waveform generated from an arbitrary waveform generator, with the modulation frequency ranging from 10 MHz to 200 MHz. The detected fluorescence emission signals are converted into digital data records by a data acquisition device, and both the digital-to-analog conversion of the modulation waveform in the arbitrary waveform generator and the analog-to-digital conversion of the fluorescence emission signals in the data acquisition device are synchronized by the same clock source.

5. The multi-functional imaging system of claim 1, wherein the bright-field microscopy imaging subsystem employs a light source within this channel's wavelength range to illuminate the sample in either reflection or transmission mode, and includes an area-scan camera positioned at the back focal plane of a camera lens to capture bright-field microscopy images of the sample.

6. The multi-functional imaging system of claim 1, wherein the optical tweezers subsystem includes a laser that outputs a collimated beam, controlled by an optical beam scanner to move the focal spot and manipulate particles within the sample, said subsystem further comprising a relay lens pair that optically relays the beam scanning axis to the back entrance aperture of the objective, matching the beam size to the aperture size upon entry, and a quadrant photodiode that detects the back-scattered light from the manipulated particle, using the offset of the measured beam center on the quadrant photodiode to estimate the force acting on the particle.

7. The multi-functional imaging system of claim 1, wherein the Raman microscopy imaging subsystem uses a laser to stimulate Raman signals from the sample located beneath the objective, and a spectrometer equipped with a line-scan camera as its sensor captures the back-scattered photons from the sample to produce the Raman spectra, these spectra being collected at various points across the sample to create Raman spectroscopic images of the sample.

8. The multi-functional imaging system of claim 1, wherein the Raman microscopy imaging subsystem is substituted with an optical coherence tomography (OCT) imaging subsystem operating near the long wavelength end supported by the microscope's objective lens, said OCT imaging subsystem including a relay lens pair that relays the beam scanning axis to the back entrance aperture of the objective, matching the beam size to the aperture size upon entry, and employing a sample arm to gather photons back-scattered from various depths within the sample, which then interfere with photons from a fixed optical delay in a reference arm, the resulting interference fringe signals being captured and processed to generate images that reveal the internal structure and functions of the sample.
